(19) United States
(12) Patent Application Publication
(10) Pub. No.: US 2017/0211872 A1
(43) Pub. Date: Jul. 27, 2017

(54) Domestic Refrigeration Appliance Having A Water Dispenser Unit That Includes A Receiving Unit For Inserting A Flavor Container

(71) Applicant: BSH HAUSGERÄTE GMBH, München (DE)

(72) Inventors: ALEXANDER GOERZ, AALEN (DE); KARL-FRIEDRICH LAIBLE, LANGENAU (DE); RALPH STAUD, MUENCHEN (DE)

(21) Appl. No.: 15/326,715

(22) PCT Filed: Jun. 22, 2015
(86) PCT No.: PCT/EP2015/063967

§ 371 Date: Jan. 17, 2017

(30) Foreign Application Priority Data
Jul. 16, 2014 (DE) 10 2014 213 798.5

(51) Int. Cl. F25D 23/12; B67D 1/08; B67D 1/00; B67D 1/07; F25D 23/02; F25D 11/00

(52) U.S. Cl. CPC F25D 23/126; F25D 23/028; F25D 11/00; B67D 1/0027; B67D 1/0078; B67D 1/07; B67D 1/0871; B67D 1/0881; B67D 1/0894; F25D 2400/361

(57) ABSTRACT

A domestic refrigeration appliance includes a water dispenser unit having a serving unit for discharging a cold beverage. The serving unit includes a receiving unit into which at least one container containing a flavoring can be inserted. In the inserted state of the container, the container is coupled to a dispensing container of the water dispenser unit containing a liquid in such a way that the cold beverage can be discharged as a mixture of the liquid and the flavoring when the serving unit is actuated.

The invention relates to a domestic refrigeration appliance having a water dispenser unit that includes a serving unit that is accessible on a front side of the domestic refrigeration appliance, for serving a cold liquid in the form of a cold beverage.

Domestic refrigeration appliances in the form of cooling appliances that have a water dispenser unit are known. These water dispenser units conventionally take a form such that they are mounted in a door that closes a receiving compartment for foodstuffs in the domestic refrigeration appliance, at least having partial components as subdivisions therein. These appliances have on an outer side of the door, which in the closed condition is thus remote from the interior or receiving compartment, a recess into which a vessel for receiving the cold beverage may be introduced. A serving unit of the water dispenser unit is arranged such that the cold beverage can then flow into the vessel that is provided by way of a serving point, which is conventionally arranged to open into an upper region of the recess.

However, in the known appliances it is only possible to serve water or ice cubes.

It is the object of the present invention to provide a domestic refrigeration appliance that enables the versatile production and the serving of different cold beverages.

This object is achieved by a domestic refrigeration appliance that has the features of claim 1.

A domestic refrigeration appliance according to the invention includes at least one water dispenser unit that has a serving unit that is accessible at a front side of the domestic refrigeration appliance, for serving a cold beverage. It may also be provided for the water dispenser unit also to be arranged with its serving unit in a receiving compartment for foodstuffs in the domestic refrigeration appliance, and thus to be covered when the door is closed. In these devices, the door has then first to be opened in order to reach the serving unit and to obtain the cold beverage therefrom.

An essential idea of the invention can be seen in the fact that the serving unit has a receiving unit into which at least one container containing a flavoring can be inserted, wherein in the inserted condition of the container the container is coupled to a dispensing container of the water dispenser unit that contains a liquid, such that when the serving unit is actuated the cold beverage can be served as a mixture of the liquid and the flavoring.

As a result of this construction, a domestic appliance such as a refrigerator or a freezer or a combined refrigerator-freezer is provided that is constructed for the purpose of receiving foodstuffs, such as food and beverages, and in addition has a water dispenser unit of quite specific form. This makes it possible to produce cold beverages of individual flavors in a versatile and thus flexible and variable manner that thus makes it possible to mix individually the water flowing out at a dispensing container of the water dispenser unit with the flavoring on the basis of the inventive receiving unit into which this specific flavoring container can be inserted. In the case of a domestic refrigeration appliance of this kind, this construction also enables more flexible utilization for the production of different cold beverages, and thus also substantially increases the benefit of this domestic refrigeration appliance to the consumer.

Preferably, it is provided for the receiving unit to be a drawer that has a hollow as the receiving region for the container. This is a particularly advantageous embodiment, which thus greatly simplifies handling for introducing the container filled with the flavoring. A drawer can be operated very simply and so the insertion or removal of the favoring container can also be performed very easily and quickly. Moreover, inherent in the construction as a drawer in this way is also a horizontal movement of displacement, with the result that the container is also received in the hollow with mechanical stability and cannot fall out during this movement of the receiving unit. Specifically when the container has also to be opened before it is inserted into the receiving unit, it is possible to prevent the flavoring from undesirably coming out of the container as a result of this construction of the receiving unit as a drawer.

Preferably, it is provided for the container having the flavoring to be a closed capsule that is opened automatically and in a defined manner on insertion into the receiving region. As a result of this construction, the containers may also be manufactured and commercialized simply and across a broad marketplace as an accessory. Any loss of flavor in the flavoring is prevented with closed containers of this kind in the form of capsules.

Because the receiving region is preferably constructed such that when the container is inserted the container opens automatically, the risk that, on insertion into the receiving region and the required prior opening of the container, the flavoring will be spilled or will come out of the container in some other way is avoided. Moreover, this construction of the receiving region for automatic opening of the inserted container also means that the opening is carried out at a desired defined location and indeed to a desired required extent. For example, the receiving region may have a spike or another kind of edge or similar that penetrates or pierces the container as it is inserted into the receiving region. This may also be performed such that during the movement of inserting the container this automatic opening is performed and the opening device or opening tool in the receiving region then, in the inserted end position of the container in the receiving region, is released again from the at least one opening that has been made in the container. This means that this opening tool is then made in a specific shape and in its location in the receiving region such that, in the end position of the container in the receiving region and in particular in the hollow thereof, the opening tool no longer blocks the opening that has been made.

Preferably, it is provided for the serving unit to have a recess for the introduction of a vessel into which the cold beverage may be fed by way of a serving point of the serving unit that opens into the recess. A recess of this kind means that the vessel can already be put into position reliably such that the cold beverage that flows out also flows reliably into the vessel and does not run past it. Moreover, a recess of this kind means that the vessel need not be held by the user while the cold beverage is being drawn off. Moreover, a recess of this kind also enables the recess base to be constructed to receive any residue of the cold beverage that nonetheless undesirably flows out or drips off, or a cleaning fluid, and, in this context, a corresponding collecting region or collecting tray to be constructed in the base of this recess. This collecting tray may preferably be removed such that it can also be emptied again without problems. As a result of this construction, the result is also that no liquid undesirably flows out or drips off the serving unit and into the receiving compartment of the domestic refrigeration appliance, or, if the serving point opens to the outside, for example on an outer side of the door, no liquid runs down the outside of the door or in general runs or drips onto the floor in front of the domestic refrigeration appliance.

Preferably, it is provided for the flavoring to be a powder. However, it may also be provided for the flavoring to be a liquid or a gel.

it may be provided for the container that contains the flavoring to be made for example from plastics material or thin metal and thus to be liquid-tight. However, it may also be provided for the container to be constructed as a pod and for example to have a liquid-permeable shell, as is the case for example with a coffee pod or tea bag. With these constructions, it is not then necessary for the receiving unit to have an opening device, and in this case, with these constructions of the flavoring container, the liquid coming out of the dispensing container then penetrates this liquid-permeable shell in any case, and accordingly receives the flavoring or the flavoring agents contained therein.

Preferably, it is provided for the flavoring to be a concentrate of a flavoring agent.

In an advantageous embodiment, the flavoring may be for example a fruit juice concentrate or a syrup concentrate or a sherbet concentrate. As an example, however, it may also be a readily soluble beverage powder such as a sherbet powder.

As an alternative, it may also be provided, when the container with the flavoring is inserted into the receiving unit and the receiving unit is put into its end position, for the flavoring already to be added automatically to the liquid in the dispensing container and then for the cold beverage to be prepared in a mixing container, by mixing the liquid and the flavoring. As an alternative, as likewise already explained, the liquid in the dispensing container and the flavoring may be arranged separately, without contact, in the water dispenser unit until the serving unit is actuated. In this embodiment, the two media are then kept separate until there is a serving request, and then the liquid from the dispensing container receives the flavoring as the former flows out in the direction of the serving point, and mixing thus takes place so to speak only during the flowing out of the liquid on the way to the serving point.

Preferably, it is provided, for the purpose of producing the cold beverage, for a required quantity of the liquid that is to be fed in from the serving container to be controlled by a control unit of the domestic refrigeration appliance. This is performed in particular in dependence on the type of flavoring and/or the quantity of flavoring and/or the type and/or the size of the flavoring container. This is a very advantageous embodiment, since in this way not only is the multiplicity of differently flavored cold beverages made possible by the domestic appliance, but in the case of a cold beverage having a specific style of flavoring the intensity of the flavor may also be adjusted individually. In this context, it may be provided for user-specific instructions to be input and stored in the control unit. In this way, user-specific requests may be taken into account automatically. It may also be provided for reference mixtures that are predetermined independently of the users to be stored in the storage unit, such that in each case these reference mixtures are used to determine the quantities of liquid added in dependence on the above-mentioned parameters.

It may also be provided for the domestic appliance to have a personal identification unit by way of which different users or consumers can be recognized individually. In dependence thereon, the cold beverage may likewise be mixed in a manner depending on the user. This may be performed for example on the basis of the programmed and stored user-specific mixing requests, and/or in dependence on the mixing requests that this individual user has made in the past.

Likewise, in an advantageous embodiment it is provided for the container with the flavoring to be inserted into the receiving unit and for the container to have readable information on the type of flavoring it has and/or on the quantity of flavoring that it contains and/or on the type of container and/or the size of the container. As regards the type of container, the material of which it is constructed and/or the shape thereof may be held as information.

In a further advantageous embodiment, it is provided for the display device of the domestic refrigeration appliance to display a quantity that has already been produced with the container and/or a number of cold beverages that have already been produced with the container and/or the quantity of cold beverages that it is still possible to produce in future and/or the number of cold beverages that are still possible in future. Information of this kind is crucial in allowing the user to see when a flavoring container should be replaced. The quantity of cold beverages in this case relates to the amount in liters or milliliters, while the number of cold beverages indicates the actual numerical quantity of how many cold beverages may still be produced with a particular volumetric quantity.

Preferably, it is provided for the receiving unit to be arranged adjacent to, in particular directly below, an operating and display device of the water dispenser unit. This immediate proximity ensures that it is clearly visible to the consumer, and the proximity of the operating or actuating facilities and the facility for fitting the flavoring container makes the appliance very user-friendly.

Preferably, it is provided for the domestic refrigeration appliance to have a control unit that is constructed such that, once the cold beverage has been fed out into a prepared vessel and the vessel has been removed from the introduction position in the water dispenser unit, a defined quantity of liquid is fed from the dispensing container for cleaning the receiving unit and the serving unit. As a result, account can also be taken of hygiene considerations. This is particularly advantageous if the domestic appliance can be fitted with at least two different containers having different flavorings, and it is possible in each case to produce cold beverages with these different flavorings individually. That is to say that if a first cold beverage is produced from the liquid from the dispensing container using the first flavoring, and then a cold beverage is to be produced with the liquid from the dispensing container using the second flavoring, a cleaning procedure of this kind after the first cold beverage has been produced is advantageous in order not to contaminate the flavor of the second cold beverage with the flavoring of the first cold beverage.

Preferably, it is provided for the serving unit to have a gas cartridge by means of which gas, in particular carbon dioxide, can be added to the cold beverage. This allows a cold beverage that is to a certain extent fizzy to be produced.

The advantageous embodiment that has been described, that the container has readable information on the type of flavoring, the quantity of flavoring, the type of container and/or the size of the container, may for example be in the form of a barcode or symbols, or for example a readable chip, in particular a wirelessly readable chip. In this context, in an advantageous embodiment a corresponding individual control of the addition of a said gas to the cold beverage may also be performed, with the result that here too a cold beverage that is more or less fizzy may be produced individually.

Preferably, it is also provided for the size of the container to be predetermined in standardized manner to a certain extent and in this context for a receiving region, in particular a hollow, to be shaped in the receiving unit accordingly. As a result of a size that is standardized in this way, it is also possible for a cold beverage that always has the same stored composition as regards the quantity of liquid from the dispensing container and the quantity of flavoring to be produced.

In an advantageous embodiment, the water dispenser unit is constructed such that in the serving of the mixed beverage, and thus of the cold beverage, the liquid is always fed by way of the flavoring container, and other liquid lines that are permanently installed in the device do not come into contact with a mixed cold beverage but only with clean water.

Further features of the invention will become apparent from the claims, the figures and the description of the figures. The features and combinations of features that are mentioned above in the description, and the features and combinations of features that are mentioned below in the description of the figures and/or are shown only in the figures, are not only usable in the combination that is indicated in each case but also in other combinations or by themselves without departing from the scope of the invention. Thus, embodiments of the invention that are not explicitly shown and explained in the figures but which are apparent from the statements made and that can be produced from separate combinations of features should also be regarded as included and disclosed.

Exemplary embodiments of the invention will be explained in more detail below with reference to schematic drawings, in which:

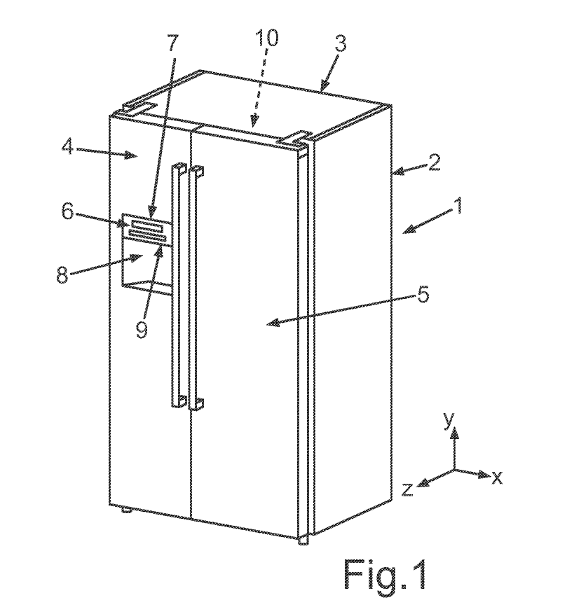

FIG. 1 shows a perspective illustration of an exemplary embodiment of a domestic refrigeration appliance according to the invention;

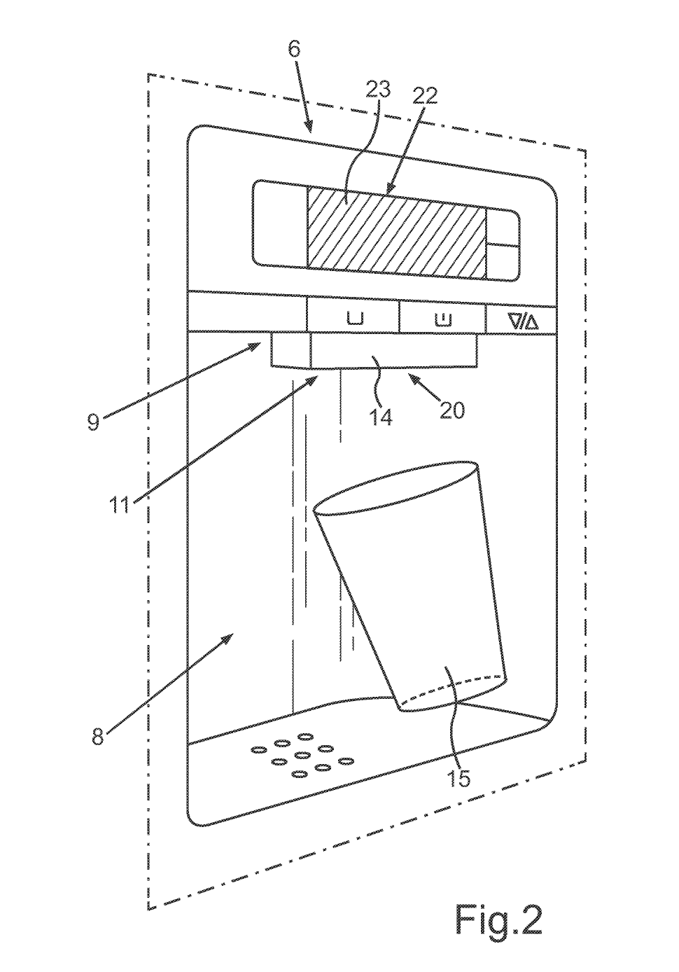

FIG. 2 shows an enlarged illustration of a partial region of the domestic refrigeration appliance from FIG. 1, in the region of the water dispenser unit;

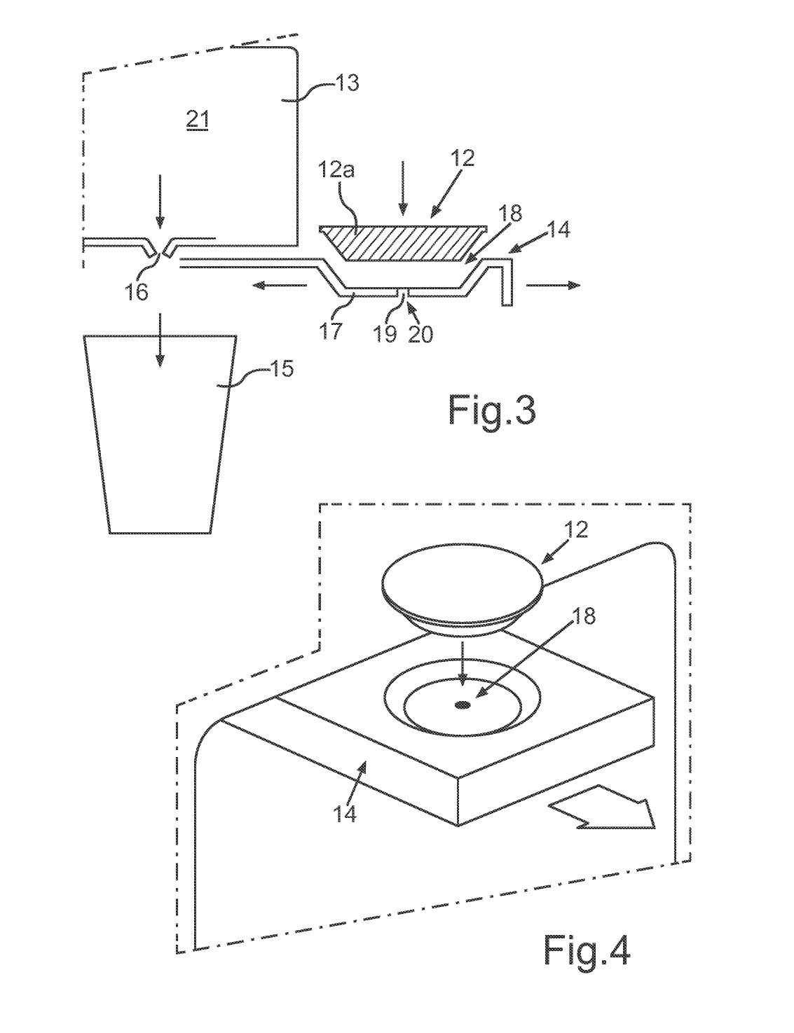

FIG. 3 shows a simplified vertical illustration in the region of the water dispenser unit, with the receiving unit opened for a container with a flavoring; and

FIG. 4 shows a perspective view of the opened receiving unit that is shown in FIG. 3, with a container with flavoring that has not yet been inserted.

In the figures, like or functionally equivalent elements are provided with the same reference numerals.

FIG. 1 shows, in a perspective illustration, a domestic refrigeration appliance 1, which may be a refrigerator or a combined refrigerator-freezer or a freezer. The domestic refrigeration appliance 1 includes a housing 2, which delimits a receiving compartment 10 in which foodstuffs such as food and beverages may be received and also cooled. The housing 2 includes a base body 3 and, in the exemplary embodiment, doors 4 and 5 that are arranged to pivot thereon. The doors 4 and 5 are arranged for closing the receiving compartment 10, it being possible for the receiving compartment 10 also to be divided into two, for example, such that a first part is closed by the door 4 and, separately and separated from this first partial region of the receiving compartment 10, a second partial region is formed that may then be closed by the door 5.

Moreover, the domestic refrigeration appliance 1 includes a water dispenser unit 6 that is constructed at least for serving cooled liquid in the form of a cold beverage. The water dispenser unit 6 may additionally be constructed also for serving ice cubes.

The water dispenser unit 6 is arranged in the housing 2, wherein it may be arranged with at least a partial component in the receiving compartment 10 and/or with partial components at least in a wall of the base body 3 or a door 4, or may be arranged entirely in a wall or door of this kind and thus may be arranged separated from the receiving compartment 10,

It may also be provided for the water dispenser unit 6 to be arranged entirely within the receiving compartment 10 and not to be accessible from outside when the door 5 is closed and the door 4 is closed.

However, the embodiment shown in FIG. 1 is preferred, in which, even when the door 4 is closed, the water dispenser unit 6 with at least partial components integrated therein is accessible.

The water dispenser unit 6 includes an operating and display device 7 that is accessible and viewable by way of a front side of the door 4. For the purpose of serving the cold beverage, the user of the domestic refrigeration appliance 1 can then introduce a receiving vessel, such as a drinking glass, into a recess 8 in the door 4, the recess 8 being a constituent part of the water dispenser unit 6. The water dispenser unit 6 moreover includes a serving device, or a serving unit 9 that is constructed for the purpose of serving the cold beverage.

in the enlarged illustration in FIG. 2, the serving unit 9 includes, also illustrated, a receiving unit 11 in which at least one container 12 having a flavoring (FIG. 3 and FIG. 4) can be received, in particular inserted.

The container 12 is coupled to a dispensing container 13 (FIG. 3) having a liquid, in particular water, in such a way that when the serving unit is actuated the desired cold beverage can be served as a mixture of the liquid in the dispensing container 13 and the flavoring from the container 12.

In the exemplary embodiment shown, according to FIG. 1 and FIG. 2, it is provided for the receiving unit 11 to have a drawer 14 (FIG. 2) that is arranged, in the immediate proximity, below operating elements of the operating and display device 7.

In FIG. 2, a situation is illustrated in which a vessel 15, for example a drinking glass, is positioned in the recess 8 such that it is arranged for receiving cold beverage that may be fed out of the serving unit 9, in particular a serving point 16.

It may be provided for the coupling between the dispensing container 13 and the receiving unit 14, and thus also to the container 12, to be such that when the serving unit 9 is actuated and thus, in accordance with a request, in order to obtain a mixed cold beverage, the liquid from the dispensing container 13 passes into the outlet opening or serving point 16 (FIG. 3) to the container 12 and flows through the latter in order to dissolve the flavoring therein, which may be contained therein for example in powder form or as a liquid, or to take up the flavoring agents thereof, and then the cold beverage flows out in the mixed form by way of an outlet opening 19, which is constructed in particular in a base 17 of a hollow 18, and into the vessel 15.

This is particularly advantageous if the shell of the container 12 is liquid-permeable and for example takes the form of a pod.

However, it may also be provided for the receiving unit 11 to have an opening element by means of which, when the container 12 is inserted into the hollow 18, the shell of the container 12 is automatically at least pierced, such that the liquid 21 (FIG. 3) in the dispensing container 13 can then also pass into the interior of the container 12 in order to receive the flavoring. In this context, a spike or an edge may for example be an appropriate opening device.

Preferably, the domestic refrigeration appliance 1 also has a control unit 22 (FIG. 2) by means of which the serving of liquid 21 from the dispensing container 13 may be controlled. In particular, it is provided, for the purpose of producing the cold beverage, for a required quantity of the liquid 21 that is to be fed in from the dispensing container 13 to be controlled by the control unit 22, in dependence on the type of flavoring in the container 12 and/or in dependence on the quantity of flavoring in the container 12 and/or in dependence on the type of container 12 and/or in dependence on the size of the container 12.

Preferably, it may also be provided for the container 12 to have, for example on an outer side 12a (FIG. 3), readable information on the type of flavoring and/or on the quantity of flavoring and/or on the type and/or the size of the container 12. This information may be detected by a detection unit, for example a sensor or the like, and be transmitted to the control unit 22 such that, in dependence on these items of information, the control of the serving of liquid from the dispensing container 13 is then in turn performed.

Preferably, it is provided for the operating and display device 7 to be constructed such that a quantity and/or number of cold beverages that have already been produced by the container 12, and/or the quantity that is still possible in future and/or the number of cold beverages possible is displayed on the display device 23 (FIG. 2).

Moreover, it is provided for the control unit 22 to be constructed such that once the cold beverage has been fed out into the vessel 15, and in particular also once the vessel 15 has been removed from the recess 8, a defined quantity, in particular of liquid 21 from the dispensing container 13 is fed out for cleaning the receiving unit 11 and/or the serving unit 9, in particular if this liquid 21 is water. This cleaning flush is particularly advantageous if the receiving unit 11 has at least two hollows into which separate containers 12 having different flavorings can be introduced.

FIG. 4 shows a perspective illustration of the pulled-out drawer 14, wherein the container 12 is shown in the still removed condition and is inserted into the hollow 18 only afterwards.

The serving unit 9 may also have a gas cartridge or a gas container by means of which gas, for example carbon dioxide, may also be added to the cold beverage that is to be produced, with the result that a fizzy cold beverage is produced.

In the embodiment shown, the recess 8 is accessible even when the door 4 is closed, with the result that the door 4 need not be opened to produce and serve a cold beverage. However, it may also be provided for the water dispenser unit 6 to be arranged entirely in the receiving compartment 10 and not to be accessible when the door 4 and/or 5 is closed.

### LIST OF REFERENCE NUMERALS

1 Domestic refrigeration appliance

2 Housing

3 Base body

4 Door

5 Door

6 Water dispenser unit

7 Display device

8 Recess

9 Serving unit

10 Receiving compartment

11 Receiving unit

12 Container

12a Outer side

13 Dispensing container

14 Drawer

15 Vessel

16 Serving point

17 Base

18 Hollow

19 Outlet opening

20 Serving point

21 Liquid

22 Control unit

23 Display device cm 1-12. (canceled)

13. A domestic refrigeration appliance, comprising:
a water dispenser unit including a dispensing container for dispensing a liquid and a serving unit for serving a cold beverage, said serving unit having a receiving unit; and
at least one container containing a flavoring, said at least one container being insertable into said receiving unit in an inserted condition;
said container, in said inserted condition, being coupled to said dispensing container causing the cold beverage to be served as a mixture of the liquid and the flavoring upon actuating said serving unit.

14. The domestic refrigeration appliance according to claim 13, wherein said receiving unit is a drawer having a hollow forming a receiving region for said container.

15. The domestic refrigeration appliance according to claim 13, wherein said container is a closed capsule.

16. The domestic refrigeration appliance according to claim 13, wherein said serving unit has a recess for introducing a vessel and a serving point opening into said recess for feeding the cold beverage into the vessel.

17. The domestic refrigeration appliance according to claim 13, wherein the flavoring is a powder or a liquid disposed in said container.

18. The domestic refrigeration appliance according to claim 13, wherein the flavoring is a concentrate.

19. The domestic refrigeration appliance according to claim 13, which further comprises a control unit for producing the cold beverage by controlling a required quantity of the liquid to be fed from said serving container in dependence on at least one of a type of the flavoring or a quantity of the flavoring or a type of said container or a size of said container.

20. The domestic refrigeration appliance according to claim 19, wherein said container has information regarding at least one of the type of the flavoring or the quantity of the flavoring or the type of said container or the size of said container, and said information is readable when said container is inserted into said receiving unit.

21. The domestic refrigeration appliance according to claim 19, which further comprises a display device displaying at least one of a quantity of cold beverages or a number of cold beverages having already been produced with said container or a quantity of cold beverages or a number of cold beverages that are still possible to be produced with said container.

22. The domestic refrigeration appliance according to claim 13, wherein said water dispenser unit has an operating and display device, and said receiving unit is disposed adjacent or directly below said operating and display device.

23. The domestic refrigeration appliance according to claim 13, wherein said water dispenser unit has a filling position for a vessel, and a control unit is configured to feed a defined quantity of the liquid from said dispensing container for cleaning said serving unit once the cold beverage has been fed into the vessel and the vessel has been removed from said filling position.

24. The domestic refrigeration appliance according to claim 13, wherein said serving unit is configured to receive a gas cartridge for adding gas or carbon dioxide to the cold beverage.
